(19) United States
(12) Patent Application Publication
(10) Pub. No.: US 2019/0300779 A1
(43) Pub. Date: Oct. 3, 2019

(54) Fracturing Process

(71) Applicant: PetroChina Company Limited, Beijing (CN)

(72) Inventors: Donghe YU, Beijing City (CN); Yiming ZHANG, Beijing City (CN); Hang CHE, Beijing City (CN); Mengmeng NING, Beijing City (CN); Juan DU, Beijing City (CN); Peng WANG, Beijing City (CN); Guangyan DU, Beijing City (CN); Yuxin PEI, Beijing City (CN); Shoumei QIU, Beijing City (CN); Xiaochao WANG, Beijing City (CN)

(73) Assignee: PetroChina Company Limited, Beijing (CN)

(21) Appl. No.: 16/365,747

(22) Filed: Mar. 27, 2019

(30) Foreign Application Priority Data
Mar. 28, 2018 (CN) 201810261747.0

(51) Int. Cl. C09K 8/68; C09K 8/66; E21B 43/24; E21B 43/26

(52) U.S. Cl. CPC C09K 8/68; E21B 43/26; E21B 43/2405; C09K 8/665

(57) ABSTRACT

The present invention provides a fracturing process, which comprises the following steps of: injecting a fracturing fluid into the formation to cause fractures in the formation and stopping the injection of the fracturing fluid after the fracture as produced reaches a preset requirement; injecting a phase transition material fluid capable of undergoing a phase transition reaction at a preset temperature and a delayed heat generating agent into the formation, wherein the delayed heat generating agent functions to generate heat after the injection of the phase transition material fluid is substantially completed, so as to cause a phase transition of the phase transition material fluid to complete the fracturing. The technical solution provided by the present invention can effectively reduce the friction resistance of the pipe string; moreover, the use of a delayed heat generating agent can effectively control the initiation and progress of the phase transition reaction.

### FIELD

The present invention belongs to the technical field of fracturing, and particularly relates to a fracturing process.

### BACKGROUND

As a major measure for stimulating oil-and-gas well and water injection well, the hydraulic fracturing technology has been widely used in the exploitation of low-permeability oil-and-gas fields, and has made important contributions to the stable production of oil-and-gas fields. The hydraulic fracturing is to pump a high-viscosity preflush to a target reservoir to form fractures and extend at high pressure, and then pump a carrier fluid incorporating a proppant. The carrier fluid can continue to extend the fractures while carrying the proppant into deep fractures. Finally, the fracturing fluid is gel broken and degraded to a low-viscosity fluid, flows to the bottom of the well, and flows back, leaving a flow channel having a high conductivity formed by the proppant propping of fractures in the formation, so to facilitate the flow of oil and gas from the far well formation to the bottom of the well.

Since the first hydraulic fracturing in the United States in 1947, the hydraulic fracturing technology has been largely developed from theoretical research to field practice after more than 60 years of development. For example, the fracture propagation model develops from two-dimensional to quasi three-dimensional and full three-dimensional; the fracturing well dynamic prediction model develops from the electrical simulation chart and the steady-state flow model to the three-dimensional three-phase unsteady model; the fracturing fluid develops from crude oil and clean water to a series of low-, medium- and high-temperature guar gum-organic boron “double-variable” fracturing fluid system and clean fracturing fluid system having high-quality, low-injury, delayed cross-linking; the proppant develops from natural quartz sand to medium and high-strength synthetic ceramsite; the fracturing equipment develops from small power cement trucks to Model 1000, Model 2000 and Model 2500 fracturing trucks; the single well fracturing operation develops from small-scale, low sand-to-liquid ratio to ultra-large, high sand-to-liquid ratio fracturing operation; the fracturing applications develops from specific low-permeability reservoirs to both ultra-low-permeability and medium-to-high permeability reservoirs (and sometimes involves sand fracturing).

However, seen from the hydraulic fracturing technology and its development, currently all fracturing techniques are based on fracturing by liquid fracturing fluid and then injecting proppant into the fracture to keep the fracture open, so as to obtain a flow channel having a high conductivity.

The conductivity of the HIWAY high-speed channel flow proposed by Schlumberger in 2010 is not affected by the permeability of the proppant. The oil and gas do not pass through the proppant filling layer, but flows through the high-conducting channel. However, its implementation needs strict requirements to the perforating process, pumping process, pumping equipment and the like, thus it has high construction cost and complicated process; likewise, it is also necessary to inject proppant into the formation to open the fractures.

Conventional guar gum fracturing fluid systems and sand phase transition fracturing process generally have the following problems:

(1) if the fracturing fluid is incompletely gel-broken and flowed back, the conductivity of the artificial fracture as formed will be severely damaged and the matrix permeability near the fracture will be reduced;

(2) in the case of a high-temperature deep well, the concentrations of the additives such as guar gums and cross-linkers are increased in order to maintain the sand-carrying capacity of the fracturing fluid at high temperature, which results in further increases of the residue content and thus the friction resistance, causing more problems such as gel-breaking and flowback;

(3) for sand fracturing, a high sand ratio is employed in order to pursue high conductivity, which may lead to problems such as sand blockage;

(4) with extended production time after construction, problems such as embedding, deformation and flowing back of conventional proppant such as ceramsite and quartz sand will cause a significant decrease in the conductivity after applying pressure, and the effective operation period is greatly shortened.

The above problems may usually lead to greatly reduced conductivity of fractures. Therefore, the fracture permeability measured in the tested well after applying pressure can often reach only one tenth or even one hundredth of the values measured in the laboratory.

During the construction process, the injection of proppant is prone to cause problems sand removal, sand blockage, injection failure and the like, so that the construction cannot reach the expected effect, and even the wellbore is blocked by sand. For this reason, petroleum workers have been focusing on the research of low-density, high-strength proppants for the purpose of making proppant easy to inject. No matter whether it is a low-density or high-density proppant, it is necessary to inject proppant from the wellhead into the formation, and the proppant will have problems of being difficult to inject and injection difficulty during the conventional sand fracturing construction process. To this end, technical personnel have developed a phase transition fracturing process in which proppant is not used. However, in the prior-art process, the phase transition reaction needs to be carried out at a certain temperature, and the temperature after the phase transition material fluid is injected into the formation can be only increased slowly depending on the temperature of the formation, which makes it difficult to effectively control the time and progress of the phase transition reaction on the ground, which tend to cause poor results or even failure of fracturing.

### SUMMARY

In order to solve the above technical problems, it is an object of the present invention to provide a fracturing process which can effectively control the occurrence or progress of a phase transition reaction.

In order to achieve the above object, the present invention provides a fracturing process comprising the following steps of:

injecting a fracturing fluid into the formation to cause a fracture in the formation and stopping the injection of the fracturing fluid after the fracture as produced reaches a preset requirement;

injecting a phase transition material fluid capable of undergoing a phase transition reaction at a preset temperature and a delayed heat generating agent into the formation;

wherein the delayed heat generating agent functions to generate heat after the injection of the phase transition material fluid is substantially completed, so as to cause a phase transition of the phase transition material fluid to complete the fracturing.

In the above fracturing process, on the one hand, the phase transition material fluid can undergo phase transition in the formation to form solid phase particles, while the non-phase transition material fluid can continue flowing, so that the self-porous proppant formed by the phase transition material fluid after the completion of the operation has a certain conductivity, and the non-phase transition material fluid can form a flow channel in the formation to improve the conductivity of the fracture. On the other hand, the delayed heat generating agent refers to a heat generating agent having a delayed heat generation time, and may be a self-delaying agent, or an agent that has a delay effect by controlling the triggering condition of the heat generating reaction. The delay is controlled generally such that the heat generating agent initially exert heat generating effect after the phase transition material fluid has substantially entered the preset formation. Therefore, the use of the delayed heat generating agent can effectively control the occurrence and progress of the phase transition reaction, thereby obtaining a better fracturing effect. Especially for low-temperature reservoirs, the heat generation effect of the delayed heat generating agent greatly improves the rate of the phase transition reaction, so that the phase transition material fluid can rapidly form a solid phase at a preset position, which shortens the time for phase transition and improves the success rate of construction.

In the above fracturing process, preferably, the delayed heat generating agent comprises a first heat generating agent, and a second heat generating agent which is capable of undergoing an exothermic reaction with the first heat generating agent.

The delayed heat generating agent functions to generate heat in such a manner that the delayed heat generating agent functions to generate heat after the injection of the phase transition material fluid is substantially completed, by controlling the encounter time of the second heat generating agent and the first heat generating agent.

In the above fracturing process, preferably, the first heat generating agent comprises sodium nitrite, and the second heat generating agent comprises an ammonium chloride solution, a formic acid solution, a formaldehyde solution or an acetic acid solution. Further preferably, the ammonium chloride solution, the formic acid solution, the formaldehyde solution, or the acetic acid solution has a mass percentage concentration of 5 to 10 wt %. Further preferably, a corrosion inhibitor may be added to each of the ammonium chloride solution, the formic acid solution, the formaldehyde solution, and the acetic acid solution, and the mass percentage concentration of the corrosion inhibitor in these solutions may be 0.5 to 1 wt %. Further preferably, the molar ratio of the first heat generating agent to the second heat generating agent is 0.5-1:1. Further preferably, the first heat generating agent is used in an amount of from 0.1 to 8 wt %, preferably from 1 to 5 wt %, based on the phase transition material fluid.

An exothermic reaction occurs immediately upon the contact of the first heat generating agent and the second heat generating agent and a large amount of gas is released along with the exothermic reaction, which gives an effect of a pore former. The amounts of the heat generating agents may be adjusted by those skilled in the art according to the actual application environment.

In the above fracturing process, preferably, in the step of injecting the phase transition material fluid capable of undergoing a phase transition reaction at a preset temperature and the delayed heat generating agent into the formation, a non-phase transition material fluid is injected together with the phase transition material fluid into the formation, and the delayed heat generating agent is previously added to the non-phase transition material fluid. Further preferably, the first heat generating agent and the second heat generating agent are injected in a process of: adding the first heat generating agent to a phase transition material fluid or the non-phase transition material fluid, and injecting it together with the phase transition material fluid or the non-phase transition material fluid into the formation; after the injection of the phase transition material fluid and the non-phase transition material fluid is substantially completed, injecting the second heat generation agent (which may be carried by the non-phase transition material fluid) into the formation to cause a phase transition of the phase transition material fluid and to complete the fracturing, wherein the second heat generating agent can undergo an exothermic reaction with the first heat generating agent.

In the above fracturing process, preferably, the non-phase transition material fluid includes one or more of a fracturing fluid, sea water, formation water, and ground fresh water, but is not limited thereto.

In the above fracturing process, preferably, the injection volume ratio of the non-phase transition material fluid to the phase transition material fluid is (0.3-0.7):(0.3-0.7). The total injection amount of the non-phase transition material fluid and the phase transition material fluid can be calculated according to the size and volume of the designed fracture.

In the above fracturing process, preferably, the phase transition material fluid contains a pore former which includes a pore-forming agent of generating gas by heating and/or a pore-forming agent of hot melt discharge. Further preferably, the pore-forming agent of generating gas by heating comprises azobisisobutyronitrile or ammonium bicarbonate; and the pore-forming agent of hot melt discharge comprises one or more of paraffin wax, dodecanol and heptane. In this scheme, the phase transition material fluid can undergo phase transition in the formation to form solid phase particles, while the non-phase transition material fluid can continue to flow, so that the self-porous proppant formed by the phase transition material fluid after the completion of the operation has a certain conductivity, and the non-phase transition material fluid can form a flow channel in the formation to improve the conductivity of the fracture.

The present invention also provides another fracturing process, comprising the following steps of:

injecting a fracturing fluid into the formation to cause a fracture in the formation and stopping the injection of the fracturing fluid after the fracture as produced reaches a preset requirement;

injecting a phase transition material fluid capable of undergoing a phase transition reaction at a preset temperature into the formation;

after the injection of the phase transition material fluid is substantially completed, causing a phase transition of the phase transition material fluid to complete the fracturing;

wherein, the raw material composition of the phase transition material fluid comprises, in percentages by mass, 10% to 60 wt % of a supramolecular building unit, 20% to 50 wt % of a supramolecular functional unit, 0.1% to 2 wt % of a dispersant, 0.1% to 1 wt % of an inorganic co-builder, and 0.1% to 1 wt % of an initiator, and the balance being a solvent; wherein the supramolecular building unit comprises a melamine-based material and/or a triazine-based material; the supramolecular functional unit comprises a dicyclopentadiene resin; and the dispersant comprises a surfactant and a hydroxyl-bearing polysaccharide substance.

The phase transition material fluid provided by the present invention may be formulated on the ground, has characteristics of low viscosity and good fluidity, and is easy to be injected into the formation. After the phase transition material fluid enters the reservoir and reacts for a period at the formation temperature (generally 60 to 120° C.), the components in the fluid can be self-assembled (theory of entropy-driven orderness of supramolecular materials) to the proppant having a certain strength and toughness to support the fracture. As compared with the existing phase transition proppant, the technical solution provided by the present invention introduces a polymer polymerization reaction in a space for supramolecular self-assembly, to have a synergetic effect of physical and chemical crosslinking, so that the toughness of the product is improved, and the time for the material fluid to form the proppant is reduced.

The preparation of the phase transition material fluid is not particularly limited as long as the components are added to the solvent and stirring uniformly. In addition, in the preparation of the above phase transition material fluid, those skilled in the art can add some conventional auxiliary agents in the supramolecular self-assembly reaction as needed.

In the above fracturing process, preferably, the raw material composition of the phase transition material fluid comprises, in percentages by mass, 30% to 40 wt % of the supramolecular building unit, 20% to 30 wt % of the supramolecular functional unit, 0.5% to 1 wt % of the dispersant, 0.5% to 1 wt % of the inorganic co-builder, 0.5% to 1 wt % of the initiator, and the balance being the solvent.

In the above phase transition material fluid, the supramolecular building unit is a base material for the supramolecular self-assembly, and those skilled in the art can select a suitable compound from the two types of common basic assembly materials, the melamine-based material and the triazine-based material. Preferably, the melamine-based material comprises melamine, an alkenyl-substituted melamine or an esterified product of melamine. Preferably, the triazine-based material comprises triazine or an alkenyl-substituted triazine. As compared with melamine or triazine, the substituted or esterified material not only has an adjustable solubility, but also gives physical and chemical crosslinking points after substitution or esterification, which makes the system more stable, and the self-assembly speed may be faster. The produced solid phase material not only has high strength but also better toughness. Both the alkenyl-substituted melamine and the alkenyl-substituted triazine as described above refer to the substance having the hydrogen elements on the amine group substituted.

In the above fracturing process, preferably, the alkenyl-substituted melamine comprises a propenyl-substituted melamine; and the esterified melamine comprises triallyl 1,3,5-cyanurate. More preferably, the propenyl-substituted melamine has a substitution degree of 2 to 3.

In the above fracturing process, preferably, the alkenyl-substituted triazine includes a propenyl-substituted triazine such as 2,4-diamino-6-diallylamino-1,3,5-triazine. More preferably, the propylene-substituted triazine has a substitution degree of 2 to 3.

For the preparation of alkenyl-substituted triazine and alkenyl-substituted melamine, conventional methods in the art can be employed. In a specific embodiment provided by the present invention, the method for preparing an alkenyl-substituted triazine may be in that: (1) cyanuric chloride is dissolved in a solvent (such as toluene), then an enol is added dropwise thereto at low temperature, and heated and reacted for a while after the completion of the dropwise addition; when the reaction is completed, it is cooled and filtered to collect a precipitate; (2) the precipitate is added to an organic solvent (e.g., dichloromethane) containing an inorganic strong base (e.g., NaOH), and reacted under heating for a while; when the reaction is completed, it is filtered to collect the filtrate. (3) the solvent is distilled off from the filtrate, and the solid is washed and refined (e.g., using a mixed solution of toluene and dichloromethane), to give an alkenyl-substituted triazine product. In a specific embodiment provided by the present invention, the method for preparing the alkenyl-substituted melamine may be in that: (1) melamine is dissolved in a solvent (e.g., N-methylpyrrolidone), a weak base (e.g., potassium carbonate) is added to form a weak alkaline environment, and then a halogenated olefin is added thereto under heating, and the reaction is continued for a while after the completion of the dropwise addition; when the reaction is completed, it is cooled and filtered to collect the filtrate; (2) the filtrate is concentrated to obtain a crude product, and the crude product is washed and refined to obtain an alkenyl-substituted melamine product.

In the above fracturing process, the surfactant can assist in the stabilization and dispersion of inorganic and organic substances in the system. Those skilled in the art can make appropriate selections depending on the particular inorganic and organic substances used. Preferably, the surfactant comprises an anionic surfactant or a nonionic surfactant.

In the above fracturing process, preferably, the anionic surfactant comprises an alkyl sulfuric acid-based surfactant, an alkyl sulfonic acid-based surfactant or an alkyl benzenesulfonic acid-based surfactant. More preferably, the alkyl sulfuric acid-based surfactant comprises sodium dodecyl sulfate, the alkyl sulfonic acid-based surfactant comprises sodium dodecyl sulfonate, and the alkyl benzenesulfonic acid-based surfactant comprises sodium dodecylbenzene sulfonate.

In the above fracturing process, preferably, the nonionic surfactant comprises a polyether-based surfactant; more preferably, the polyether-based surfactant comprises a polyoxyethylene ether type surfactant; further preferably, the polyoxyethylene ether type surfactant includes octylphenol polyoxyethylene ether or nonylphenol polyoxyethylene ether.

In the above fracturing process, the dispersant may be a mixed system of a surfactant and a hydroxyl-bearing polysaccharide substance. The hydroxyl-bearing polysaccharide substance can not only achieve dispersion via its high viscosity of these polymer materials per se, but also assist the supramolecular self-assembly by the hydroxyl groups in the molecule, accelerating the self-assembly of the molecules to shorten the molding time. As for the ratio of the surfactant to the hydroxyl-bearing polysaccharide substance used can be adjusted by those skilled in the art according to actual needs. For example, in a particular embodiment, the ratio by weight of the surfactant to the hydroxyl-bearing polysaccharide substance may be 1:(0.1-10). The hydroxyl-bearing polysaccharide substance may include one or more of hydroxypropylmethyl cellulose, polyvinyl alcohol, hydroxymethyl cellulose, ethyl cellulose and sucrose fatty acid ester.

In the above fracturing process, the supramolecular functional unit includes a dicyclopentadiene resin. As compared with the small-molecule compound used in the prior art, this scheme introduces a polymer polymerization reaction into the space for supramolecular self-assembly to give a synergetic effect of physical and chemical cross-linking, which increases the toughness of the product and shortens the time for forming the material.

In the above fracturing process, the inorganic co-builder can be used to form an inorganic gel, which plays an intermediate role in the supramolecular construction, and it may be selected from conventional inorganic co-builders in the art. Preferably, the inorganic co-builder comprises sodium bicarbonate, or a combination of phosphoric acid and calcium chloride.

In the above fracturing process, the role of the initiator functions is mainly to initiate the polymerization reaction, and a suitable initiator can be selected depending on the reactants. The initiator may include a peroxide initiator, and preferably may be one or more of dibenzoyl peroxide, dodecanoyl peroxide, cumene hydroperoxide, tert-butyl hydroperoxide, dicumyl peroxide, di-tertert-butyl peroxide, tertert-butyl peroxybenzoate, tertert-butyl peroxypivalate, diisopropyl peroxydicarbonate, dicyclohexyl peroxydicarbonate and diethylhexyl peroxydicarbonate.

In the above fracturing process, the solvent serves to assist in dissolving the organic materials, and the suitable solvent can be selected depending on the determined components. The solvent includes a benzene-based solvent; preferably one or more of styrene, divinyl benzene, xylene, and toluene.

In the above fracturing process, preferably, the supramolecular building unit further comprises a building aid, which comprises one or more of 1,4-butanediol diacrylate, N,N-methylene bisacrylamide, and triallyl isocyanurate.

In the above fracturing process, preferably, the raw material composition of the phase transition material fluid further includes a pore former. The use of a pore former is another important improvement of the technical solution provided in the present invention. In the technical solution disclosed in CN 105971579, what is formed by the phase transition of the material fluid is a solid support material without pores. During the construction process, the solid support material formed after phase transition, per se, does not have the conductivity, while the production of the conductivity after closure of a fractures requires that the proppants are spaced apart from each other, that is, a channel-like propping must be formed. In the fracturing construction process, the phase transition fluid and the non-phase transition fluid are simultaneously injected into the reservoir, so that the non-phase transition fluid passes through and vacates the fluid passage to produce the conductivity of a fracture. However, during the construction process, the phase transition fluid may accumulate and then subject to phase transition at some local locations, such as some natural branch fracture channels or natural cavern fractured channels. If this happens, the proppant after phase transition is very likely to cause partial blockage. In order to overcome the above defects, it is more effective to improve the post-fracturing permeability and the conductivity, and to avoid the local blockage after phase transition caused by the accumulation of the fracturing fluid. In the technical solution provided by the present invention, the phase transition material fluid containing the pore former can form a self-porous solid support material after the phase transition in the formation. Even if the fracturing fluid is locally accumulated, the reservoir fluid can also flow through the self-generated pores, which can effectively realize a high conductivity of the fracture, and further improve the operation effect of the fracturing.

The technical solution provided by the invention is applicable to the improved fracturing stimulation and injection stimulation of conventional sandstone reservoirs, carbonate reservoirs and other complex oil and gas reservoirs, and can greatly improve the construction efficiency. It involves using an immiscible composite fracturing fluid system to open and form artificial fractures of a certain geometrical size, and forming various independent “solid dams” by one or two fluids in the fracture via a physical method and a chemical method to support the fracture, thus forming a “channel-like flow path” have a high permeability while forming simultaneously self-porous proppant which can improve the conductivity, thereby increasing the yield.

In the above fracturing process, preferably, the raw material composition of the phase transition material fluid includes 0.2% to 5 wt % of a pore former, in percentage by mass. The pore former may include a pore-forming agent of generating gas by heating and/or a pore-forming agent of hot melt discharge. Further preferably, the pore-forming agent of generating gas by heating comprises azobisisobutyronitrile or ammonium bicarbonate; and the pore-forming agent of hot melt discharge comprises one or more of paraffin wax, dodecanol and heptane.

In the above fracturing process, preferably, in the step of injecting the phase transition material fluid capable of undergoing a phase transition reaction at a preset temperature into the formation, a delayed heat generating agent is also injected into the formation together. The delayed heat generating agent is used to function to generate heat after the injection of the phase transition material fluid is substantially completed. Further preferably, the delayed heat generating agent comprises a first heat generating agent and a second heat generating agent, wherein the second heat generating agent is capable of undergoing an exothermic reaction with the first heat generating agent. The delayed heat generating agent functions to generate heat in such a manner that the delayed heat generating agent functions to generate heat after the injection of the phase transition material fluid is substantially completed, by controlling the encounter time of the second heat generating agent and the first heat generating agent.

In the above fracturing process, preferably, the first heat generating agent comprises sodium nitrite, and the second heat generating agent comprises an ammonium chloride solution, a formic acid solution, a formaldehyde solution or an acetic acid solution. Preferably, the ammonium chloride solution, the formic acid solution, the formaldehyde solution, and the acetic acid solution have a mass percentage concentration of 5 to 10 wt %. Further preferably, a corrosion inhibitor may be added to the ammonium chloride solution, the formic acid solution, the formaldehyde solution, and the acetic acid solution, and the mass percentage concentration of the corrosion inhibitor in these solutions may be 0.5 to 1 wt %. Further preferably, the molar ratio of the first heat generating agent to the second heat generating agent is 0.5-1:1. Further preferably, the first heat generating agent is used in an amount of from 0.1 to 8 wt %, preferably from 1 to 5 wt %, based on the phase transition material fluid.

In the above fracturing process, preferably, the first heat generating agent and the second heat generating agent are injected in a process of:

adding the first heat generating agent to the phase transition material fluid or the non-phase transition material fluid, and injecting it together with the phase transition material fluid or the non-phase transition material fluid into the formation;

after the injection of the phase transition material fluid and the non-phase transition material fluid is substantially completed, injecting the second heat generation agent into the formation to cause a phase transition of the phase transition material fluid and to complete the fracturing, wherein the second heat generating agent can undergo an exothermic reaction with the first heat generating agent.

The technical solution provided by the invention may comprise two operation modes, one of which is a process without injecting a heat generating agent (which can be applied to a high temperature reservoir), and the other is a process injecting a heat generating reagent (which can be applied to a low temperature reservoir). The heat generating agent can release a large amount of heat and gas through a chemical reaction, thereby shortening the time for phase transition and increasing the probability of successful operations. At the same time, for the phase transition material fluid to which the pore former is added, the gas released by the heat generating reagent via a chemical reaction allows the phase transition material to form a large number of pores therein to improve the conductivity of the supporting fracture. Thus, the time for phase transition can be accelerated by adding a heat generating reagent if the reservoir has a low temperature.

In a specific embodiment, an operation mode without injecting a heat generating agent may include the following steps of:

injecting a fracturing fluid into the formation to cause a fracture in the formation and stopping the injection of the fracturing fluid after the fracture as produced reaches a preset requirement;

injecting a non-phase transition material fluid and a phase transition material fluid into the formation;

injecting a displacement fluid into the formation to cause both the non-phase transition material fluid and the phase transition material fluid to enter the formation; and

well shut-in for holding pressure.

The time of well shut-in for holding pressure may be 30 to 200 mins. During the process of well shut-in for holding pressure, the phase transition material fluid may be changed from a liquid phase to a solid phase relying on heat of the formation to support the fracture.

In a specific embodiment, an operation mode injecting a heat generating agent may include the following steps of:

injecting a fracturing fluid into the formation to cause a fracture in the formation and stopping the injection of the fracturing fluid after the fracture as produced reaches a preset requirement;

injecting a first heat generating agent, a non-phase transition material fluid and a phase transition material fluid into the formation;

injecting a second heat generating agent into the formation to cause a phase transition of the phase transition material fluid;

injecting a displacement fluid into the formation to cause the whole second heat generating agent to enter the formation to complete the fracturing, wherein the second heat generating agent can undergo an exothermic reaction with the first heat generating agent.

In the technical solution provided by the present invention, the first heat generating agent and the second heat generating agent can chemically react to release heat and gas, which shortens the time for the phase transition material to change from a liquid phase to a solid phase to support the fracture.

In the above fracturing process, preferably, the non-phase transition material fluid includes one or more of a fracturing fluid, sea water, formation water, and ground fresh water, but is not limited thereto.

In the above fracturing process, preferably, the time of well shut-in for holding pressure may be 30 to 200 mins.

Beneficial effect of the present invention:

As compared with the conventional hydraulic fracturing, in one aspect, the technical solution provided by the present invention involves, instead of injection of a proppant into the formation, injecting a phase transition material fluid into the formation that has been fractured. The phase transition material fluid is in flowable liquid phase on the ground and during the process of injection, which can form a solid phase material to support the fracture, under the chemical/physical action of the heat generating agent, after entering the reservoir. Due to the absence of solid phase injection, the technical solution provided by the present invention can effectively reduce the friction resistance of the pipe string, which may reduce the requirements on the construction equipment, the ground pipeline, the wellhead and construction string, effectively decrease the construction costs, and lower down the construction risk and safety hazard. On the other hand, the use of a delayed heat generating agent can effectively control the initiation and progress of the phase transition reaction, thereby obtaining a better fracturing effect.

### DRAWINGS

FIG. 1 is graph illustrating data for the conductivity of the rock plates.

### DETAILED DESCRIPTION

In order to more clearly understand the technical features, the objects and the beneficial effects of the present invention, the technical solutions of the present invention will now be described in details below, which should not be construed as limiting the implementable scope of the present invention.

### Example 1

This example provides a phase transition material fluid.

The phase transition material fluid provided in this example was prepared as follows:

50 g of xylene was weighed, and then 40 g of 2,4-diamino-6-diallylamino-1,3,5-triazine, 30 g of a dicyclopentadiene resin, 0.5 g of hydroxypropyl methylcellulose, 0.5 g of sodium dodecyl sulfate, 0.5 g of phosphoric acid, 0.5 g of calcium chloride, and 1 g of dibenzoyl peroxide were added thereto. The above components were all placed in a flask, and stirred well at room temperature to prepare the phase transition material fluid, which was denoted as HPP₁.

The phase transition material fluid in this example was placed in a constant-temperature oil bath, elevated to 90° C. and allowed to react for 1 hour, to obtain a bead-like, bulky solid, that is, a proppant, which was denoted as H₁. It can be seen that the phase transition material fluid provided in this example can undergo phase transition from a liquid phase to a solid phase, and therefore can be used for phase inversion fracturing.

The proppant obtained as above was tested for performance, and the test data is shown in Table 1.

TABLE 1
Test data for performance of the proppant

| | | | Crushing rate (%) | | |
|---|---|---|---|---|---|
| | | | Bearing | Bearing | Bearing |
| | Bulk density | Actual density | pressure | pressure | pressure |
| Sample | g/cm³ | g/cm³ | 52 MPa | 86 MPa | 96 MPa |
| H₁ | 0.53 | 1.04 | ≤0.3 | ≤8.9 | ≤18 |

### Example 2

This example provides a phase transition material fluid.

The phase transition material fluid provided in this example is prepared as follows:

50 g of xylene was weighed, and then 40 g of propenyl-substituted triazine, 30 g of a dicyclopentadiene resin, 0.5 g of polyvinyl alcohol, 0.5 g of sodium dodecyl sulfate, 0.5 g of phosphoric acid, 0.5 g of calcium chloride, 1 g of dibenzoyl peroxide and 5 g of ammonium bicarbonate were added sequentially thereto. The above components were all placed in a flask, and stirred well at room temperature to prepare the phase transition material fluid, which was denoted as HPP₃.

The phase transition material fluid N in this example was placed in a constant-temperature oil bath, elevated to 100° C. and allowed to react for 0.5 hour, to obtain a bead-like, bulky solid, that is, a proppant, which was denoted as H₂. It can be seen that the phase transition material fluid provided in this example can undergo phase transition from a liquid phase to a solid phase, and therefore can be used for phase inversion fracturing.

The proppant obtained as above was tested for performance, and the test data is shown in Table 2.

TABLE 2
Test data for performance of the proppant

| | | | Crushing rate (%) | | |
|---|---|---|---|---|---|
| | | | Bearing | Bearing | Bearing |
| | Bulk density | Actual density | pressure | pressure | pressure |
| Sample | g/cm³ | g/cm³ | 52 MPa | 86 MPa | 96 MPa |
| H₂ | 0.43 | 1.03 | ≤0.33 | ≤9.5 | ≤23 |

Since the proppant H₂ has a porous structure, its bulk density is significantly smaller than that of H₁.

The proppant H₁ obtained in Example 1 and the H₂ obtained in Example 2 were tested for its permeability in a process as following:

the proppants H₁ and H₂ were screened to separate 40 to 60 mesh solid phase particles, and the screened solid phase particles were pressed into a small rock core having a length of 8 cm and a diameter of 2.54 cm at 10 MPa by a rock core machine. The small rock core was placed in a rock core flow experimental instrument to measure its gas permeability. The test results were: K_{H1}=426 mD and K_{H2}=617 mD. From the test data for five samples, it can be seen that the generation of the pores can greatly increase the permeability of the proppant.

### Example 3

This example provides a fracturing process.

An indoor simulated experiment was conducted by using a ground outcrop as the experimental material with a rock-core conductivity simulating device. Firstly, the outcrop was cut into rock plates (8 cm×5 cm×1.75 cm) according to the device requirements, and the two rock plates were overlapped and put into the rock core fixture. The rock-plate conductivity experiment was carried out by simulating a fracturing construction process at a temperature of 80° C. with altered injection pressure and confining pressure.

The experiment was carried out in the order of “injecting a fracturing fluid agent A→simultaneously injecting a non-phase transition material fluid M (in which the first heat generating agent B is added) and a phase transition material fluid N from two acid injection tanks→injecting a second heat generating agent C→injecting a displacement fluid to force the agents in the pipeline to the rock plate→holding pressure for 60 min→releasing pressure”. The fracture was tested by altering the closure pressure to obtain data of changes in the conductivity. The conductivity of the fracture supported by the phase transition material during the fracturing construction was simulated. The initial conductivity measured before the rock plate experiment was 2.4 (μm²·cm), wherein:

the fracturing fluid agent A was a conventional guar gum fracturing fluid having 1 wt % of guar gum and 99 wt % of water;

the non-phase transition material fluid M had a composition of: 0.5 wt % of guar gum+5 wt % of sodium nitrite+94.5 wt % of water;

the phase transition material fluid N was prepared as follows: 50 g of xylene was weighed, and then 40 g of 2,4-diamino-6-diallylamino-1,3,5-triazine, 30 g of a dicyclopentadiene resin, 0.5 g of hydroxypropyl methylcellulose, 0.5 g of sodium dodecyl sulfate, 0.5 g of phosphoric acid, 0.5 g of calcium chloride, and 1 g of dibenzoyl peroxide were added thereto;

the volume ratio of the non-phase transition material fluid M to the phase transition material fluid N was 1:1;

the first heat generating agent B was sodium nitrite in an addition amount of 3 wt % based on the total weight of the phase transition material fluid, and the molar ratio of the first heat generating agent B to the second heat generating agent C is 0.5:1;

the second heat generating agent C was an aqueous solution of ammonium chloride (having a concentration of 6 wt %); and

the displacement fluid was an aqueous solution of ammonium chloride having a concentration of 3 wt %.

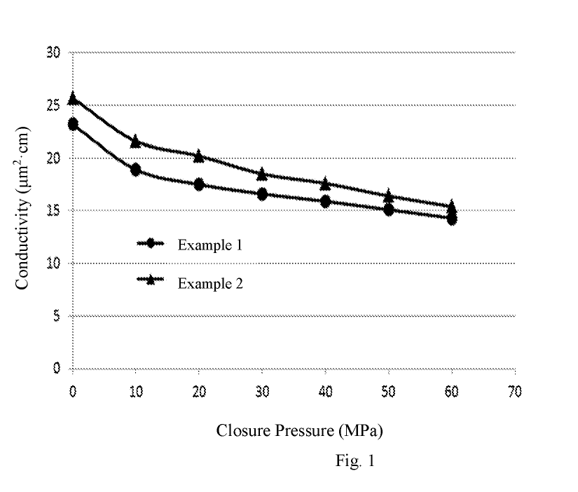

The experimental results are shown in FIG. 1. After the rock plate was subjected to the experiment for a fracturing conductivity, the initial conductivity of 2.4 μm²·cm is increased up to 23.2 μm²·cm, indicating that the successful fracture support is realized by the fracturing. At the same time, as the closure pressure of the fracture increases, the conductivity of the fracture is reduced, which is, however, still many times higher than the initial permeability. When the closure pressure reaches 60 MPa, the conductivity of the fracture is still 14.3 μm²·cm left, which demonstrates that the fracturing process provided by the present invention can adapt to the high pressure condition under the ground. When the construction is completed, the solid phase material after phase transition realizes the support to the formation fracture.

### Example 4

This example provides a fracturing process.

An indoor simulated experiment was conducted by using a ground outcrop as the experimental material with a rock-core conductivity simulating device. First, the outcrop was cut into rock plates (8 cm×5 cm×1.75 cm) according to the device requirements, and the two rock plates were overlapped and put into the rock core fixture. The rock-plate conductivity experiment was carried out by simulating a fracturing construction process at a temperature of 80° C. with altered injection pressure and confining pressure.

The experiment was carried out in the order of “injecting a fracturing fluid agent A→simultaneously injecting a non-phase transition material fluid M and a phase transition material fluid N from two acid injection tanks→injecting a displacement fluid to force the agents in the pipeline to the rock plate→holding pressure for 60 min→releasing pressure”. The fracture was tested by altering the closure pressure to obtain data of changes in the conductivity. The conductivity of the fracture supported by the phase transition material during the fracturing construction was simulated. The initial conductivity measured before the rock plate experiment was 3.1 (μm²·cm), wherein:

the fracturing fluid agent A was a conventional guar gum fracturing fluid having 1 wt % of guar gum and 99 wt % of water;

the non-phase transition material fluid M had a composition of: 0.5 wt % of guar gum+99.7 wt % of water;

the phase transition material fluid N is prepared as follows: 50 g of xylene was weighed, and then 40 g of propenyl-substituted triazine, 30 g of a dicyclopentadiene resin, 0.5 g of polyvinyl alcohol, 0.5 g of sodium dodecyl sulfate, 0.5 g of phosphoric acid, 0.5 g of calcium chloride, 1 g of dibenzoyl peroxide and 5 g of ammonium bicarbonate were added sequentially thereto;

the volume ratio of the non-phase transition material fluid to the phase transition material fluid was 1:1; and

the displacement liquid was an aqueous solution of ammonium chloride having a concentration of 3 wt %.

The experimental results are shown in FIG. 1. After the rock plate was subjected to the experiment for a fracturing conductivity, the initial conductivity of 3.1 μm²·cm is increased up to 21.6 μm²·cm, indicating that the successful fracture support is realized by the fracturing. At the same time, as the closure pressure of the fracture increases, the conductivity of the fracture is reduced, which is, however, still many times higher than the initial permeability. When the closure pressure reaches 60 MPa, the conductivity of the fracture is still 13.2 μm²·cm left, which demonstrates that the fracturing process provided by the present invention can adapt to the high pressure condition under the ground. When the operation is completed, the solid phase material after phase transition realizes the support to the formation fracture.

What is claimed is:

1. A fracturing process comprising the following steps of:
injecting a fracturing fluid into the formation to cause a fracture in the formation and stopping the injection of the fracturing fluid after the fracture as produced reaches a preset requirement;
injecting a phase transition material fluid capable of undergoing a phase transition reaction at a preset temperature and a delayed heat generating agent into the formation;
wherein the delayed heat generating agent functions to generate heat after the injection of the phase transition material fluid is substantially completed, so as to cause a phase transition of the phase transition material fluid to complete the fracturing.

2. The process according to claim 1, wherein the delayed heat generating agent comprises a first heat generating agent, and a second heat generating agent which is capable of undergoing an exothermic reaction with the first heat generating agent;
wherein the delayed heat generating agent functions to generate heat in such a manner that the delayed heat generating agent functions to generate heat after the injection of the phase transition material fluid is substantially completed, by controlling the encounter time of the second heat generating agent and the first heat generating agent.

3. The process according to claim 2, wherein the first heat generating agent comprises sodium nitrite, and the second heat generating agent comprises an ammonium chloride solution, a formic acid solution, a formaldehyde solution or an acetic acid solution;
preferably, the ammonium chloride solution, the formic acid solution, the formaldehyde solution, or the acetic acid solution has a mass percentage concentration of 5 to 10 wt %;
further preferably, the molar ratio of the first heat generating agent to the second heat generating agent is 0.5-1:1.

4. The process according to claim 1, wherein in the step of injecting the phase transition material fluid capable of undergoing a phase transition reaction at a preset temperature and the delayed heat generating agent into the formation, a non-phase transition material fluid is injected together with the phase transition material fluid into the formation, and the delayed heat generating agent is previously added to the non-phase transition material fluid.

5. The process according to claim 4, wherein the injection volume ratio of the non-phase transition material fluid to the phase transition material fluid is (0.3-0.7):(0.3-0.7).

6. The process according to claim 1, wherein the phase transition material fluid contains a pore former;
the pore former includes a pore-forming agent of generating gas by heating and/or a pore-forming agent of hot melt discharge; and
preferably, the pore-forming agent of generating gas by heating comprises azobisisobutyronitrile or ammonium bicarbonate, and the pore-forming agent of hot melt discharge comprises one or more of paraffin wax, dodecanol and heptane.

7. A fracturing process comprising the following steps of:
injecting a fracturing fluid into the formation to cause a fracture in the formation, and stopping the injection of the fracturing fluid after the fracture as produced reaches a preset requirement;
injecting a phase transition material fluid capable of undergoing a phase transition reaction at a preset temperature into the formation;
after the injection of the phase transition material fluid is substantially completed, causing a phase transition of the phase transition material fluid to complete the fracturing;
wherein the raw material composition of the phase transition material fluid comprises, in percentages by mass, 10% to 60 wt % of a supramolecular building unit, 20% to 50 wt % of a supramolecular functional unit, 0.1% to 2 wt % of a dispersant, 0.1% to 1 wt % of an inorganic co-builder, and 0.1% to 1 wt % of an initiator, and the balance being a solvent;
wherein the supramolecular building unit comprises a melamine-based material and/or a triazine-based material; the supramolecular functional unit comprises a dicyclopentadiene resin; and the dispersant comprises a surfactant and a hydroxyl-bearing polysaccharide substance.

8. The process according to claim 7, wherein the melamine-based material comprises melamine, an alkenyl-substituted melamine or an esterified product of melamine;
preferably, the triazine-based material comprises triazine or an alkenyl-substituted triazine; and
preferably, the hydroxyl-bearing polysaccharide substance comprises one or more of hydroxypropylmethyl cellulose, polyvinyl alcohol, hydroxymethyl cellulose, ethyl cellulose and sucrose fatty acid ester.

9. The process according to claim 7, wherein the supramolecular building unit further comprises a building aid, which comprises one or more of 1,4-butanediol diacrylate, N,N-methylene bisacrylamide, and triallyl isocyanurate.

10. The process according to claim 7, wherein the raw material composition of the phase transition material fluid includes 0.2% to 5 wt % of a pore former, in mass percentage;
the pore former includes a pore-forming agent of generating gas by heating and/or a pore-forming agent of hot melt discharge; and
preferably, the pore-forming agent of generating gas by heating comprises azobisisobutyronitrile or ammonium bicarbonate, and the pore-forming agent of hot melt discharge comprises one or more of paraffin wax, dodecanol and heptane.

11. The process according to claim 7, wherein in the step of injecting the phase transition material fluid capable of undergoing a phase transition reaction at a preset temperature into the formation, a delayed heat generating agent is also injected into the formation together;
the delayed heat generating agent is used to function to generate heat after the injection of the phase transition material fluid is substantially completed;
preferably, the delayed heat generating agent comprises a first heat generating agent and a second heat generating agent, wherein the second heat generating agent is capable of undergoing an exothermic reaction with the first heat generating agent;
the delayed heat generating agent functions to generate heat in such a manner that the delayed heat generating agent functions to generate heat after the injection of the phase transition material fluid is substantially completed, by controlling the encounter time of the second heat generating agent and the first heat generating agent.
